(19) United States
(12) Patent Application Publication
(10) Pub. No.: US 2007/0274882 A1
(43) Pub. Date: Nov. 29, 2007

(54) Reactor Comprising a Heat Exchanger Area Comprising an Insert

(76) Inventors: Jurgen Mosler, Castrop-Rauxel (DE); Torsten Balduf, Afungstadt (DE); Dennis Yu-Chiang Thong, Marl (DE); Jorg Leistner, Dortmund (DE); Stefan Nordhoff, Recklinghausen (DE); Michael Bernd Fricke, Gescher (DE); Oliver Becker, Marl (DE)

Correspondence Address: SMITH MOORE LLP, P.O. BOX 21927, GREENSBORO, NC, 27420, US

(21) Appl. No.: 10/588,333

(22) PCT Filed: Feb. 4, 2005
(86) PCT No.: PCT/EP05/01116

§ 371 Date: Jun. 8, 2007

(30) Foreign Application Priority Data
Feb. 5, 2004 (DE) 10 2004 005 863.6

(51) Int. Cl. B01J 15/00

(52) U.S. Cl. 422/198; 562/542

(57) ABSTRACT

The invention relates to a reactor at least comprising, connected with each other in fluid-communicating fashion: a reaction area, whereby the reaction area comprises at least one solid-state catalyst; a coolable heat exchanger area, whereby the heat exchanger area comprises at least one housing, whereby the housing accommodates at least partially an insert, whereby the insert comprises a plurality of elements, a process for oxidation of a hydrocarbon using the reactor, an oxidized hydrocarbon product obtainable by this process, chemical products, such as fibers, sheets, formed bodies and the like based on this oxidized hydrocarbon product as well as the use of this oxidized hydrocarbon product in chemical products of this type.

This application is a national stage application under 35 U.S.C. 371 of international application No. PCT/EP2005/001116 filed Feb. 4, 2005, published Aug. 18, 2005 as WO 2005/075064 A1, and claiming priority to German Application No. DE 10 2004 005 863.6 filed Feb. 5, 2004, the disclosures of which are expressly incorporated herein by reference.

Embodiments of the present invention and various aspects thereof relate to a reactor, to a process for oxidation of a hydrocarbon using the reactor, to an oxidized hydrocarbon product obtainable by this process, to chemical products such as fibers, sheets, formed bodies, and the like based on this oxidized hydrocarbon product, as well as to the use of this oxidized hydrocarbon product in chemical products of these types.

A number of heterogeneous gas phase reactions are known in the art, in particular gas phase oxidations in which the desired reaction product is obtained from reactants in one, two, or more steps.

With gas phase reactions, in particular with one step gas phase reactions, often it can be observed that,the product gas leaving the reaction area is brought into contact with a fluid medium in a so-called quench area. In the section between the reaction area and the quench area, further undesired reactions can occur that can lead to an increase in impurities and thus, generally, to a reduced yield and increased complexity of purification. In particular, the temperature of the gaseous product leaving the reaction area being too high causes reactions to occur in this section. It is thus conceivable to provide, between the reaction area and quench area, a heat exchanger area in which the product gas leaving the reaction area can be cooled.

For economic reasons, it is desirable to carry out the above-mentioned two- or multistep reactions to the extent possible without the time-consuming work-up of intermediate products of the individual reactions. When carrying out multistep reactions of this type, it is desirable, however, to ensure that the products obtained in the individual reaction steps are communicated to the next reaction step in a form as unchanged form as possible. An example of a multistep reaction of this type is the synthesis of acrylic acid, which commonly occurs by a heterogeneously catalyzed gas phase oxidation process of propylene with oxygen, at a catalyst situated in a solid aggregate state, at temperatures between about 200 and about 450° C. In a first step, propylene is reacted with oxygen to acrolein at a temperature within the range from about 300 to about 450° C. The acrolein obtained from this reaction area is then oxidized to acrylic acid in a further reaction area in the presence of oxygen. A risk exists, however, that the acrolein obtained in the first reaction area spontaneously combusts, or that the acrolein further reacts to water and carbon. With both of these undesired reactions, carbon-containing deposits that disturb the operation of the reactor can form. In addition, the desublimation of high-boiling by-products, such as maleic acid anhydride (MSA) or phthalic acid anhydride (PHTA), can lead to the formation of deposits. In order to prevent this, the acrolein-comprising gas mixture from the first reaction area is cooled in a coolable heat exchanger area. In order to avoid to the extent possible the further undesired reactions of the acrolein, it is desirable for the cooling to less than about 280° C. to occur as quickly as possible. It is further possible that a coolable heat exchanger area, followed by a quench area, follows the last reaction area of the two- or multistep reactions in the same way as after the reaction area of the one-step reaction.

In order to optimize the function of heat exchanger areas for use on an industrial scale, various packing materials present as individual elements, such as balls, rings, fragments, wire, fibers, ribbons, and the like, in particular raschig rings, are recommended as flow obstacles in the heat exchanger area and disclosed for the improvement of the heat transfer.

These packing materials are, however, disadvantageous, since, on the one hand, they lead to significant loss of pressure and, furthermore, a rapid deposition of combustion residues, inter alia—referred to as coking in the following, is observed in industrial scale operation. With many packing materials, this coking increases disadvantageously when actually an increased conducting away of heat is desired.

Because of the coking of the packing materials in the heat exchanger area and of the heat exchanger area as such, the operation of the reactor must often be interrupted for cleaning purposes. This is undesired, because the reactor must generally be shut down, which is time-consuming, and after the shut down, during which the cleaning occurs, be started up again, which is also time-consuming. The significant down times arising therefrom are commercially very disadvantageous.

In general, the various aspects of the embodiments of the present invention lessen or even overcome the disadvantages arising in the art.

In particular, an aspect of an embodiment according to the present invention reduces the coking of heat exchanger areas and/or of packing materials provided in these heat exchanger areas.

A further aspect of an embodiment according to the present invention reduces down times of reactors.

In addition, an aspect of an embodiment according to the present invention, in addition to reducing a tendency to coke heat exchanger areas and/or the packing materials used therein, achieves as high as possible a heat removal from these heat exchanger areas.

Additionally, an aspect of an embodiment according to the present invention reduces the formation of undesired by-products and side-reactions for gas phase reactions, in order to increase the yield.

According to another aspect of an embodiment according to the present invention, the cleaning of the heat exchanger area and/or of the packing materials located in the heat exchanger area can be made easier.

Furthermore, an aspect of an embodiment according to the present invention provides gas phase reaction products of high purity and high yield, in order to reduce the purification effort after the reaction.

An aspect of an embodiment according to the present invention also reduces the formation of deposits from reaction by-products, such as MSA or PTHA, in the synthesis of acrylic acid.

In addition, an aspect of an embodiment according to the present invention achieves a good heat transfer with little coking with a small amount of material.

Accordingly, an aspect of an embodiment according to the present invention relates to a reactor, at least comprising a reaction area and a coolable heat exchanger area, connected with each other in a fluid-communicating fashion. The reaction area includes at least one solid-state catalyst. The heat exchanger area includes at least one housing at least partially including an insert. The insert includes a plurality of elements.

Reactors according to an aspect of an embodiment according to the present invention include all reactors that are usable in gas phase reactions, in another aspect in heterogeneous gas phase reactions, and that are known to those skilled in the art. Such reactors usually include high-grade steel reactors, or black steel (“Schwarzstahl”) such as pipe bundle reactors, plate reactors, and the like. According to the present invention, by “fluid-communicating” it is to be understood that at least gases are transportable, as is possible through, for example, pipes.

The reaction area, which in an aspect is temperature-controllable, comprises at least one solid-state catalyst. This can be, on the one hand, a powder catalyst, which is present as full contact as pellets, on a carrier, or not on a carrier. According to another aspect of an embodiment, the walls of the reaction area can also be coated with a solid-state catalyst. The spatial design of the reaction area has no restrictions, as it depends upon the respective mode of reaction. Thus, the reaction area can be present, on the one hand, in pipe-like form or in the form of plates arranged parallel to each other. “Thermoplates” represent a particular form of the plates presented parallel to each other. These are plates that are connected with each other in sections and, in this way, provide a cushion-like hollow space structure. Reactors of this type are described in such detail in DE 101 08 380 A1 for catalyst-coated thermoplates and in DE 100 19 381 A1 for thermoplates provided with powder catalyst.

Another aspect of an embodiment according to the present invention includes a group of reactors including, as a reaction area between two walls, slit-like designed reaction areas. Reactors of this type, also known as “slit-reactors,” are described, for example, in WO 02/18042 A1.

The coolable heat exchanger area following the reaction area includes at least one housing, which in an aspect can directly follow the reaction area. Housings of this type are suitable for the purpose of heat exchange and can include all forms known to those skilled in the art. Among this plurality of forms, on the one hand pipe forms and on the other hand two housings comprising plates and running substantially parallel to each other, can be used. In one aspect, the pipe-like housings can be used in reactors whose heat reaction area comprises pipes. In another aspect, the catalyst-comprising pipes of the reaction area are extended, maintaining the same diameter, and the catalyst is replaced in the thus-extended pipe by one or more inserts.

In the case that the construction includes walls running substantially parallel to each other, this housing, comparable with the reaction area, can comprise similar to the there-defined thermoplates or slit-reactors, whereby these do not comprise catalyst, but, rather, one or more inserts. In one aspect, the inner space of the housing, in particular the area of the inner space of the housing, which receives the insert, is formed to the extent possible free of bends or angles and as straight as possible. In this way, the insert can be removed more easily from the housing.

According to an aspect of an embodiment of the present invention, the insert includes at least one of the following properties, determined according to the test methods described herein:
(A) a heat pressure quotient Λ1 at an empty pipe speed v of 0.485 m/s of in one aspect greater than about 1.11, in another aspect greater than about 10, and in yet another aspect at least about 50, as well as in yet a further aspect at least about 70 W/m²/K/(mbar/m); or
(B) a heat pressure quotient Λ2 at an empty pipe speed v of 0.728 m/s of in one aspect greater than about 1.53, in another aspect greater than about 2, in yet another aspect greater than about 12, and in yet a further aspect at least about 60, as well as in even yet another aspect at least about 90 W/m²/K/(mbar/m); or
(C) a heat pressure quotient Λ3 at an empty pipe speed v of 0.970 m/s of in one aspect greater than about 1.81, in another aspect greater than about 3.33, in yet another aspect greater than about 14, and in yet a further aspect at least about 70, as well as in even yet another aspect at least about 110 W/m²/K/(mbar/m).

Each of the individual properties A, B, or C represents in itself an aspect of an embodiment according to the present invention. Further aspects of embodiments according to the present invention arise from property combinations according to the following combinations of letters: AB, AC, BC, or ABC. In an aspect of an embodiment of the present invention, the thermal compression quotient A, B, and/or C may have an upper limit and are therefore less than about 1000, in another aspect less than about 500, in yet another aspect less than about 350, and in a further aspect less than about 200, and in even yet another aspect less than about 150 W/m²/K/(mbar/m). This can apply for individual heat pressure components and also for the property combinations that arise from the following combinations of letters: AB, AC, BC, or ABC. It is further possible that the individual heat pressure quotients are present in ranges bound by the above lower limits and upper limits.

In an aspect of an embodiment, the invention relates to a reactor at least comprising a reaction area and a coolable heat exchanger area connected in fluid-communicating fashion. The reaction area includes at least one solid-state catalyst. The heat exchanger area includes at least one housing at least partially accommodating an insert. In an aspect, the insert includes at least one of the following, in another aspect all properties (A) to (C), determined according to the test methods described herein.

A heat pressure quotient Λ is formed by division of the heat transfer coefficient, k, and the pressure loss, Δp, based on a sample length. Typically, A does not reach more than about 800 W/m²/K/(mbar/m).

According to an aspect of an embodiment of the present invention, the insert includes a degree of perforation of at least about 30, in another aspect at least about 60, and in yet a further aspect at least about 80. In yet another aspect moreover, an insert includes a degree of perforation within the range from about 90 to about 99. The degree of perforation is determined by a volumetric measurement (“Auslitem”).

In addition, in an aspect according to the present invention, in contrast to the individually present raschig rings, a part of the plurality of elements of a given insert can be formed contiguously, in another aspect in one piece, and in yet another aspect from one and the same material.

In yet a further aspect, at least one part of the elements can be formed from a material that is at least partially fiber-like. Here, in one aspect, about 2 to about 30, in another aspect about 2 to about 15, and in yet a further aspect about 2 to about 10 elements/cm insert lengths of the plurality of elements are formed contiguously, in yet another aspect as one piece, from the at least partially fiber-like materials.

As fiber-like materials, in principal all materials known to those skilled in the art are considered, whose length is substantially longer, in one aspect at least about ten-fold, in another aspect at least about a hundred-fold, and in yet a further aspect at least about a thousand-fold longer than the diameter of this material. As materials for the fiber-like materials, metals, metal alloys, polymers, in particular high-temperature resistant polymers such as carbon fibers or polyfluorinated polymers (Teflon®) as well as ceramic materials, in particular basalt wools are considered. When selecting suitable materials for use for the elements or the fiber-like material, one selects individual materials or material combinations according to whether these materials allow, on the one hand, a sufficient rigidity of the insert, a sufficient resistance to chemicals, and a satisfactory manufacturability of the inserts.

In one aspect of an embodiment according to the present invention, at least a part of the plurality of the elements is arranged around a core. In another aspect of an embodiment according to the present invention, this core accommodates at least a part of the plurality of the elements. As a core, a longitudinal element may be considered. The core can be formed from at least two longitudinal elements. The at least two longitudinal elements can be connected with each other via a loop-like area, in an aspect a single piece. The longitudinal elements can also be formed from fiber-like materials. Generally, one selects the material for the core according to the same criteria as apply to the fiber-like material.

In one aspect of an embodiment according to the present invention, the elements can be accommodated by the core in such a way that the elements pass through the core. This can be achieved according to another aspect of an embodiment of the present invention in that at least two of the longitudinal elements are twisted around each other to form one or more windings. The thus-obtained windings accommodate at least one of the elements. In one aspect, it has been found to be particularly advantageous that within the range from about 1 to about 20, in another aspect from about 4 to about 15, and in yet a further aspect from about 6 to about 10 elements are accommodated in one of these windings, whereby in this case, the winding has a rotation of the longitudinal element of about 360°.

In one aspect of an embodiment according to the present invention, the windings can be designed such that the elements are clamped by these windings in such a way that the elements are held in a given position so as not to be changeable by the action of the gravity of the standing insert. The elements can be accommodated by a core which, compared to its diameter, is clearly longer than the average of the diameter, in one aspect by at least about 10 times, in another aspect by at least about 100 times, and in yet a further aspect by at least about 500 times. A core designed in such a way has a longitudinal axis around which the elements are arranged and would be, according to aspect of an embodiment of the present invention, helically wound. In one aspect, from about 2 to about 20, in another aspect from about 4 to about 15, and in yet a further aspect from about 6 to about 10 elements form a section of this helix which describes a complete circular arc. A complete circular arc of the helix is present if a line formed, starting from the central axis of the core up to the point of the element at the furthest distance from this central axis matches the same line of another, following element.

In another form of the insert, element groups are disposed in annular arrangement around a core. Annuli of this type comprise in one aspect from about 2 to about 20, in another aspect from about 4 to about 15, and in yet a further aspect from about 6 to about 10 elements. In one aspect of an embodiment, at least part of the elements made from wire, while in another aspect, all of the plurality of the elements are made from wire. Likewise in an aspect, the core can also be made from wire, in another aspect metal wires. Suitable metals for these metal wires include brass alloys, platinum alloys, in one aspect steels, in another aspect high-grade steels, and in yet another aspect spring steels.

In one aspect of an embodiment according to the present invention, it is desirable that an insert within an inner space cross-section of a housing fills substantially the inner space cross-section. For example, this may be the case with a circular pipe-like housing if the inner circular space cross-sectional area is filled to at least about 80% by a circular insert area based on an imaginary circle formed by an arrangement of elements of the insert. With a housing having an angular internal space, an angular inner space cross-section area arising therein may be covered by an outlined area formed by an arrangement of elements of the insert, in one aspect to at least about 60%, and in another aspect to at least about 80%.

In one aspect of an embodiment according to the present invention, the housing may include a cylindrical inner space. This may be particularly advantageous if the insert accommodated by this inner space is likewise in cylindrical form. In this context, the cylindrical inner space and the insert of cylindrical form can be alike, or the insert of cylindrical form in its circular radius in unmounted state is a little larger, in one aspect by about 1% to about 30%, in another aspect from about 2% to about 20%, and in a further aspect from about 5% to about 10% of that of the cylindrical inner space. The circular radius differences can decrease with increasing stiffness of the material. This measure contributes to the force-fit of the insert in the housing.

This has an advantage that a pliable and thus flexible insert can be pressed, depending on the dimensions of the housing, at the inner walls thereof. This allows for using an insert itself as a stop within the housing and further enables the removal of impurities adhering to the inner walls of the housing, in particular carbon-containing deposits such as carbon particulate matter, when removing the insert.

In this context, in one aspect of an embodiment according to the present invention, an inner wall of a housing may be contacted by at least a part of the plurality of elements. Such contacting can be such that in the contact-free state outside of the housing, the elements at least slightly move away from their contact positions. In this way, elements of an insert press at the inner wall of a housing and thus result in the insert not being able to slip of its own accord within the housing.

In the present invention, the elements used can be any suitable elements known to those skilled in the art for the purpose of the present invention, in particular for the improvement of heat transfer, gas mixing, and reducing of carbon-containing deposits. In various aspects of an embodiment of the present invention, elements can comprise sheet forms, loop forms, or elements with sheet forms combined with elements with loop forms. Elements formed as loops appear to be beneficial. According to an embodiment of the present invention, an insert includes in one aspect within a range from about 1 to about 10 elements/cm, in another aspect from about 1 to about 6 elements/cm, and in yet another aspect about 1 to about 4 elements/cm.

In an aspect according to an embodiment of the present invention, inserts having a self-supporting skeletal-like structure have been fond to be beneficial. In turn, such inserts include at least two longitudinal elements forming a substantially centrally arranged core. These longitudinal elements are wound around each other and a plurality of loops is held in the openings formed by the winding of the longitudinal elements. The plurality of the individual loops, which start at the core, extends helically along the longitudinal core. Some inserts of this type according to an aspect of an embodiment according to the invention, for example, are disclosed in GB-patent 1 570 530. Other inserts of this type according to another aspect of an embodiment according to the invention, as well as processes for their production are disclosed in GB 2 097 910 A. Yet other inserts of this type according to yet another aspect of an embodiment according to the invention, are commercially available from the company Cal Gavin Ltd., England, and sold under the trade name HiTRAN®.

In the context of carrying out two-step reactions and multistep reactions according to an aspect of an embodiment of the present invention, at least one further reaction area can follow the heat exchanger area. For the case that these multistep reactions are different synthesis steps, the catalyst in the reaction area and a further catalyst in the further reaction area are different. The selection of the catalyst in the reaction area and the selection of the further catalyst in the further reaction area depend upon which reactions are to be carried out in the respective reaction areas.

An aspect of an embodiment of the present invention that also relates to a reactor, an insert, which is according to various aspects of an embodiment of the present invention, which can extend beyond the heat exchanger area, at least partially extends into the reaction area. In this context, the part of the insert that extends into the reaction area includes a catalyst. The catalyst can be present as a coating on at least one of the elements. In addition, at least one of the elements can be formed from a catalyst material. Thus for example, in reactions catalyzed by platinum, elements made from platinum wire can be used. Further, the elements can also carry or hold solid-state catalyst particles because of their spatial design. In addition, the insert can better distribute the reactant gas and the reaction gases in the reaction area; in this case, the insert need not be coated with catalyst. It is sufficient if the reaction area and/or the housing is coated or lined with catalyst.

Another aspect of an embodiment of the present invention also relates to a reactor with a reaction area having an insert according to various aspects of an embodiment of the present invention, whereby this insert comprises a catalyst. The housing details and forms of the catalyst are also valid for this variant.

Furthermore, yet another aspect of an embodiment of the present invention relates to a process for oxidation of a hydrocarbon, wherein the hydrocarbon as a gas is converted in a reactor according to various aspects of an embodiment of the present invention into an oxidized hydrocarbon product. In an aspect, a hydrocarbon may be used for oxidation, in another aspect an unsaturated hydrocarbon may be used, and in yet another aspect propane may be used. Acrolein or acrylic acids are examples of oxidized hydrocarbon products according to aspects of an embodiment of the present invention. Acrolein may be obtained in a first step in a reactor with a first reaction area and acrylic acid from the thus-obtained acrolein in a further reaction area.

Examples of suitable catalysts, common reactors, reaction conditions, and purification methods for the production of acrolein and acrylic acid are disclosed in “Stets Geforscht,” Vol. 2, Chemieforschung im Degussa-Forschungszentrum Wolfgang 1988, pages 108-126, chapter “Acrolein und Derivate” D. Arntz und Ewald Noll.

In addition, various aspects of embodiments of the present invention relate to fibers, sheets, formed bodies, food or feed additives, pharmaceuticals, cosmetics, foams, superabsorbent polymers, paper additives, leather additives, or textile additives comprising or based upon an oxidized hydrocarbon product according to various aspects of embodiments of the present invention, such as acrylic acid.

Further, various aspects of embodiments of the present invention relate to the use of an oxidized hydrocarbon product, such as acrylic acid, in or for fibers, sheets, formed bodies, food or feed additives, pharmaceuticals, cosmetics, foams, superabsorbent polymers, paper additives, leather additives, or textile additives.

Examples of suitable superabsorbent polymers, their production, composition, properties, and use are disclosed in “Modern superabsorbent polymer technology”, Fredrick L. Buchholz, Andrew T. Graham, Viley-VCH, 1998.

The invention is more closely illustrated in the following by non-limiting figures.

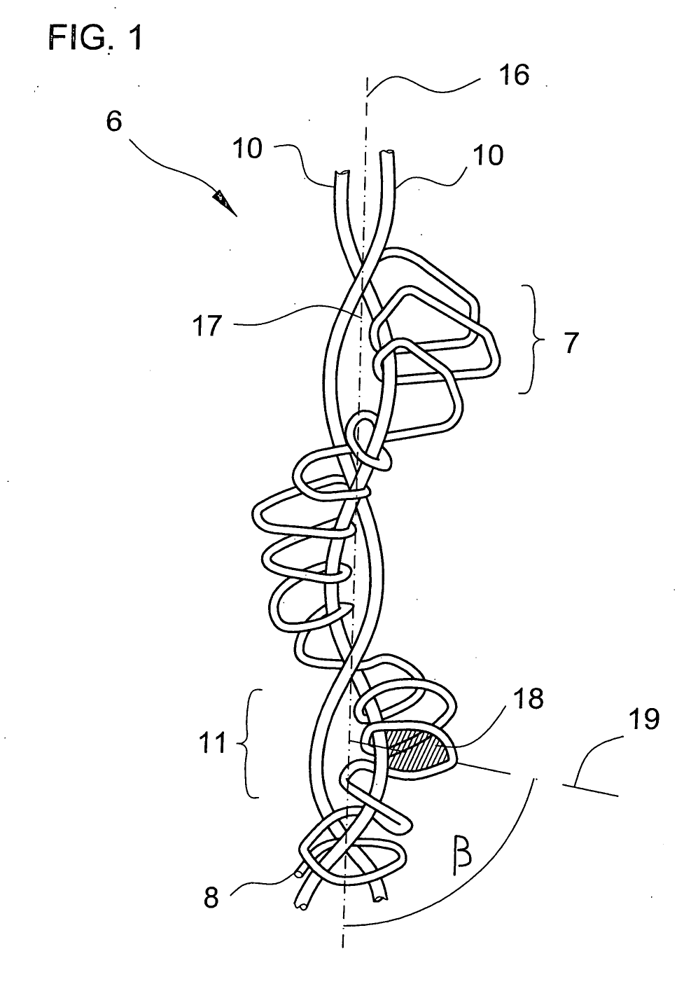

FIG. 1 shows a schematic representation of an insert according to an embodiment of the present invention;

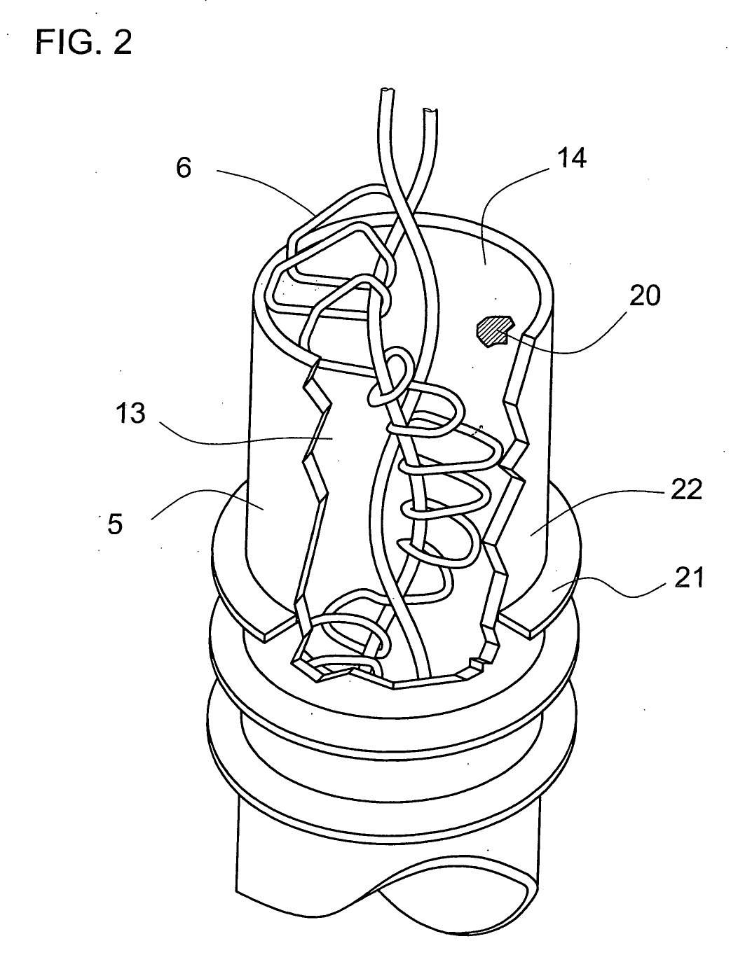

FIG. 2 shows the schematic representation of a housing according to an embodiment of the present invention with an insert according to an embodiment of the present invention;

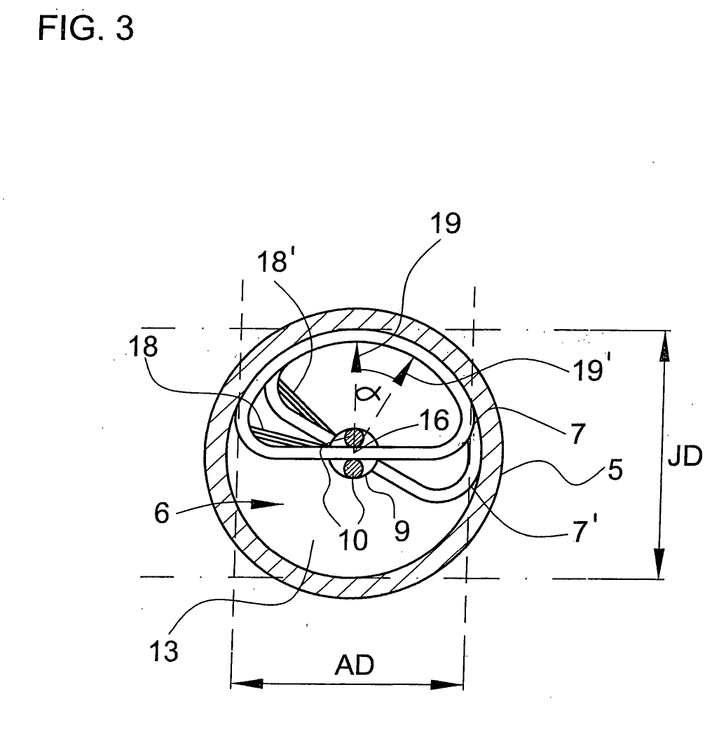

FIG. 3 shows a view of a housing according to an embodiment of the present invention that comprises an insert according to an embodiment of the present invention;

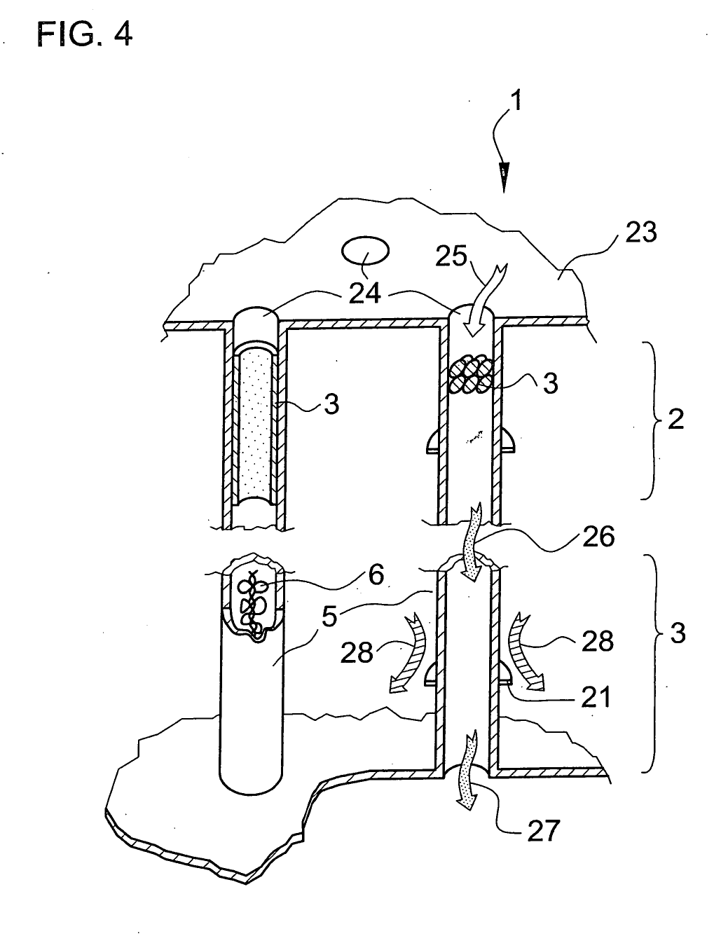

FIG. 4 shows a schematic representation of a part of a reactor according to an aspect of embodiment of the present invention;

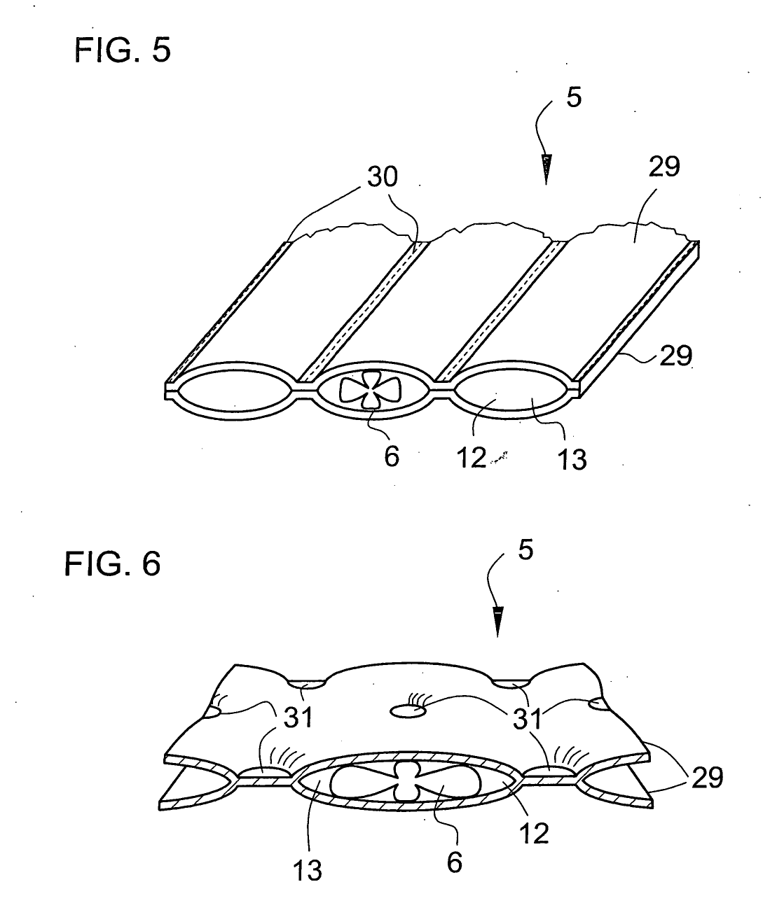

FIG. 5 shows another schematic representation of a housing according to another aspect of an embodiment of the present invention;

FIG. 6 shows a further schematic representation of a housing according to yet another aspect of an embodiment of the present invention;

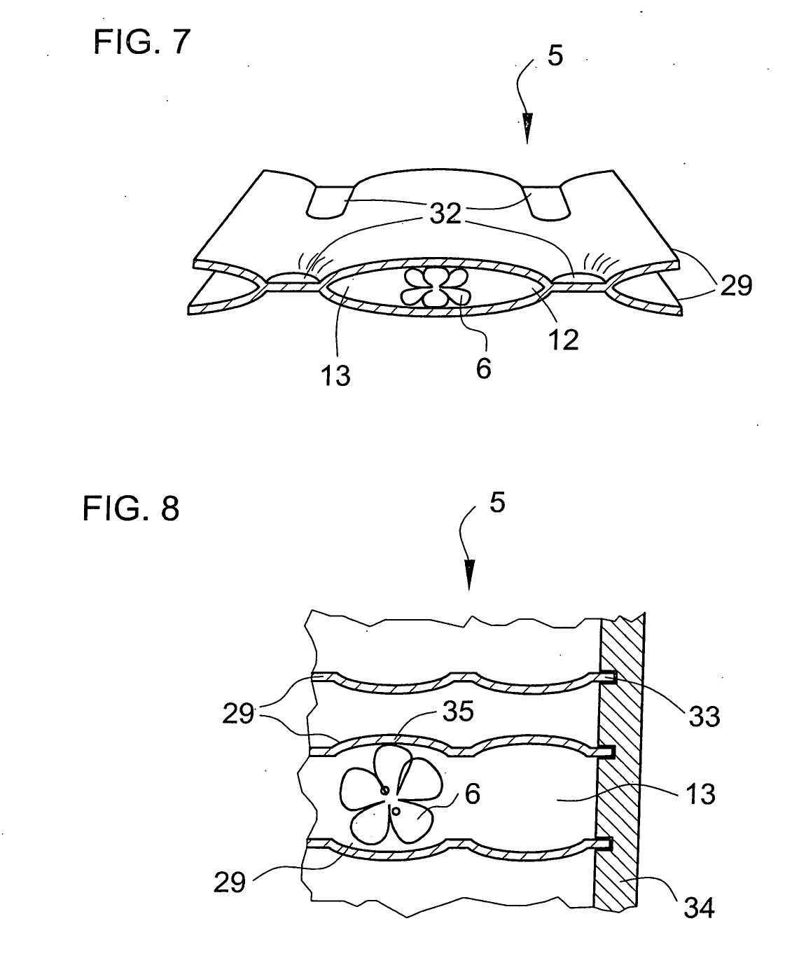

FIG. 7 shows another schematic representation of embodiment of a housing according to still another aspect of an embodiment of the present invention;

FIG. 8 shows a schematic representation of a housing according to an embodiment of the present invention arranged in a reactor.

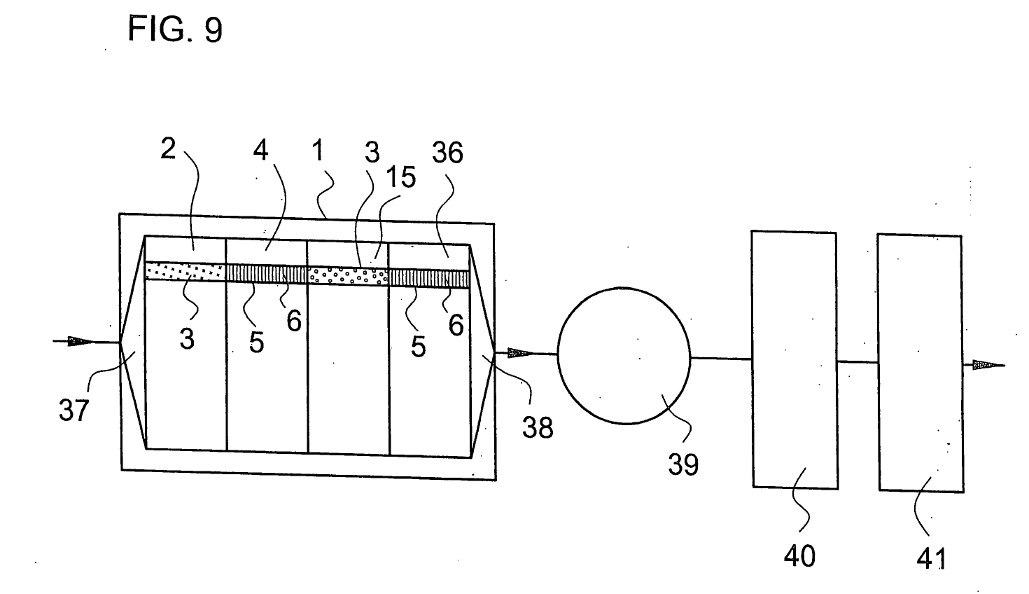

FIG. 9 shows a diagram-like representation of a reactor according to an embodiment of the present invention with a quench, purification, and polymerization unit attached thereto.

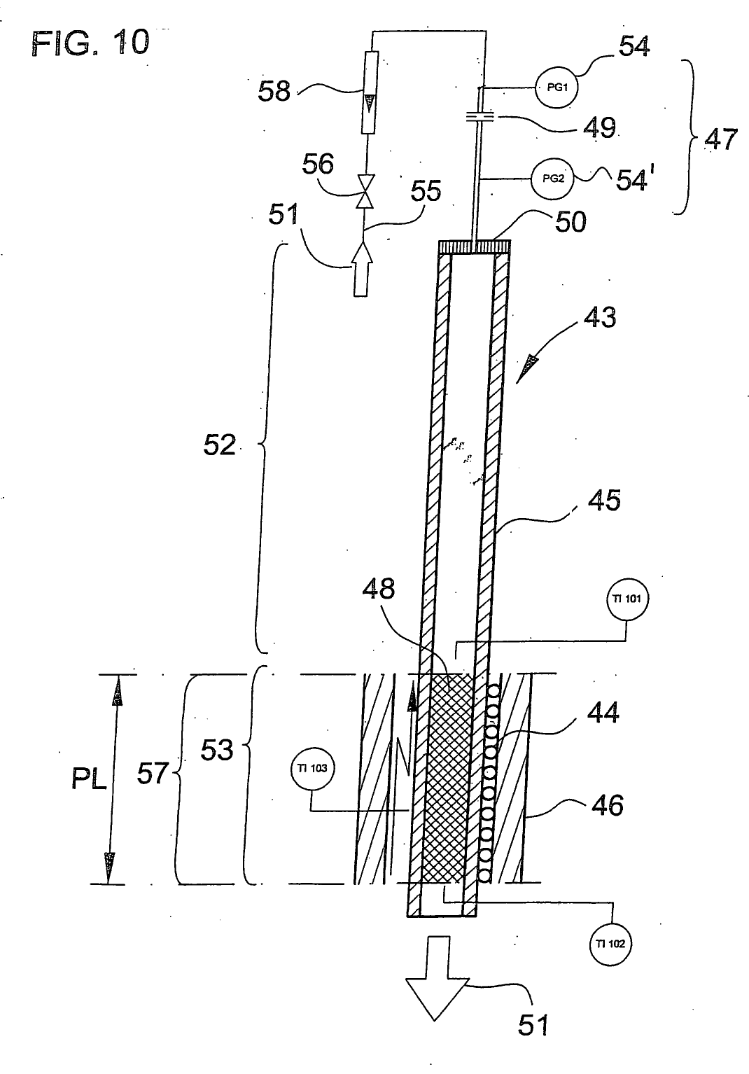

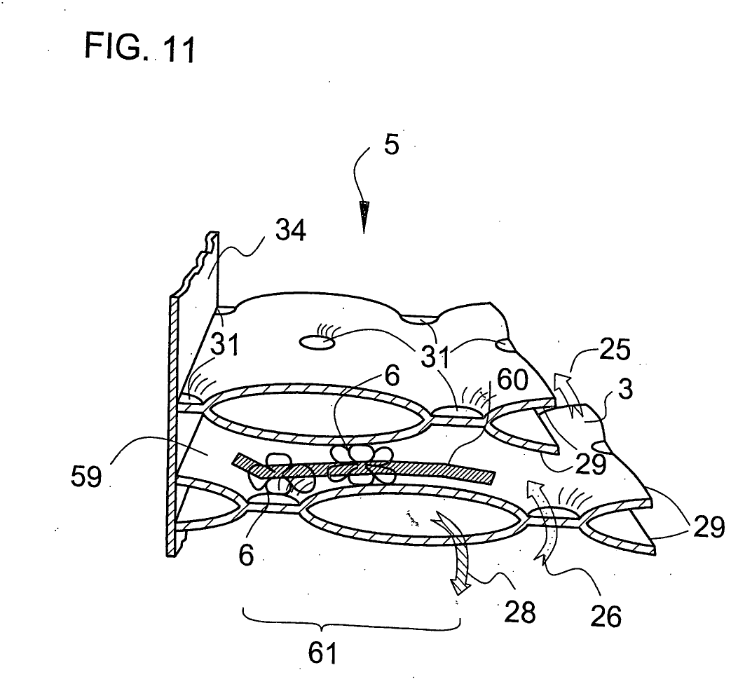

FIG. 10 shows a sketch for the construction of the measurement device for selection of inserts suitable for various aspects of an embodiment of the present invention; and

FIG. 11 shows another schematic representation of a housing in cross-section according to an embodiment of the present invention.

FIG. 1 is representation of a cut-out section an insert 6 according to an aspect of an embodiment of the present invention. This insert 6 includes a core 9 formed using two longitudinal elements 10 wound around each other and made from metal wire. Through a twisting of the longitudinal elements 10, windings 11 that accommodate the elements 7 in recesses 17, form the core 9. Because the element 7 is formed from a fiber-like material 8, in the present case likewise a metal wire, the elements 7 are held by means of the windings 11 in the core 9. The windings 11 and the guide of the fiber-like material 8 are designed such that the elements 7 are braced in the form of loops about a central longitudinal axis 16 formed by the core 9. An element area 18 is formed, in respect of element 7, in its largest area extension. An element axis 19 cuts element area 18 at its longest extension, seen from longitudinal axis 16. Between the longitudinal axis 16 and element axis 19 lies an angle β that can be in one aspect within the range from about 45 to about 135°, in another aspect within the range from about 75 to about 115°, and in a further aspect within the range from about 85 to about 95°.

The closer the angle β is to 90°, the easier it is for the inserts 6 to be moved in both directions within a pipe without jamming. Furthermore, the ability to move without jamming increases with a design of element 7 which can be round, arc-shaped, or with as few edges as possible toward the pipe inner wall. The elements 7 are, due to an accommodation of one or more elements 7 in the recesses 17 of the windings 11, through the turning of the longitudinal elements 10 counter to each other, like a spiral staircase around the core 9 forming a helical element. A “density” (as number of elements per given length of the insert 6 and the degree of perforation) can, on the one hand, be increased by an accommodation of more elements 7 in a respective windings 11, or by a greater counter twisting relative to each other of the longitudinal elements 10 which form the core 9, or by a combination of each these measures. Through this described design for this aspect of an embodiment of an insert 6, a plurality of elements 7 are connected to core 9 and an insert 6 with a self-supporting stiffness can be obtained that is sufficiently capable of withstanding the flow ratios in a housing 5. In addition, it is advantageous to form a loop at at least one end of an insert 6 so as to accommodate a movement of inserts 6. In an aspect of this embodiment, such a loop can be formed using longitudinal elements 10.

In FIG. 2, according to an aspect of an embodiment of the present invention relating to a housing 5, is depicted that includes an insert 6 as described in FIG. 1. The inner space 13 formed by the inner wall 14 of a housing 5 is filled by the insert 6 such that by connecting areas of the element 7 with the inner wall 14, the insert 6 is fit by force-fit into the inner space 13 of the housing 5. By means of this measure, on the one hand, the slipping of the insert 6 within the housing 5 is made more difficult and, on the other hand, upon taking the insert 6 out of the housing 5, deposits 20 such as carbon particulate matter adhering to the inner wall 14 are at least partially removed. For heat removal, the housing 5 includes optional cooling elements 21 at its outer wall 22. The construction depicted in FIG. 2 can likewise be in a reactor that includes an insert including a catalyst.

FIG. 3 shows a transverse cross section of a housing 5 including an insert 6. The housing 5 includes an inner space 13 with an inner space diameter ID. Abutting the inner wall 14 of the housing 5 are two loop-like formed elements 7 and 7′ that are held by two longitudinal elements 10 of the core 9 and arranged centrally in the inner space 13. The elements 7 and 7′ are formed from metal wire fiber-like material 8, whereby the fiber-like material 8 is held in place by the two longitudinal elements. The two elements, 7 and 7′ respectively, include element areas 18 and 18′, as indicated with shading, that are dissected in the middle in the same way by element axes 19 and 19′ extending from the central longitudinal axis 16. The two element axes 19 and 19′ form an angle α, which can be in one aspect within the range from about 5 to about 180°, in another aspect within the range from about 10 to about 130°, and in a further aspect from about 30 to about 100°.

The diameter at which elements 7 and 7′, after mounting in the housing 5, abut the inner wall 14 of the housing 5 includes an abut diameter AD. ID can be greater than AD. Furthermore, AD can be in one aspect about 10 to about 90% of ID, in another aspect about 20 to about 70% of ID, and in a further aspect lies within a range of about 25 to about 50% of ID.

FIG. 4 depicts a cutaway view of a reactor 1 with a reaction area 2 and a heat exchanger area 3 according to an aspect of an embodiment of the present invention. The reactor 1 includes a reactor plate 23 with a plurality of holes 24, through which a reactant gas 25 is communicated to the solid-state catalyst 3 that can be present as catalyst pellets or also as layer catalyst. At catalyst 3, a chemical reaction occurs creating a hot product gas 26 that is introduced into a housing 5 and which it leaves as cooled product gas 27. This cooling in housing 5 can be improved by adding an insert 6 through which the hot product gas 26 can flow and at which the hot products gas can be swirled. The heat given up to the housing 5 in this way is conducted away via an optional cooling element 21 applied at the outer wall 22 of the housing 5 by passing a cooling agent flow 28.

In FIG. 5, a housing 5 is depicted in which the inner space 13 includes a lens-like inner space cross-section 12 according to an aspect of an embodiment of the present invention. Furthermore, the inner space 13 is designed such that two plates 29 of sheet-like material arranged substantially parallel to each other are connected along substantially parallel straight lines and without by means of weld seams 30 as connecting area, whereby the weld seams 30 are in an aspect not interrupted. The insert 6 accommodated by the inner space 13 of such a housing 15 likewise can include a lens-like cross section.

In FIG. 6 represent another a housing 5 according to an aspect of an embodiment of the present invention. Here, two plates 29 of sheet-like material are arranged substantially parallel to each other and welded to each other at various connection points 31 that in an aspect can be arranged offset to each other. The inner space 13 includes an inner space cross-section 12 formed between two connection points 31 in lens-like form. The areas lying between the connection points 31 and forming the inner space 13 of the housing 5 are cushion-like. This thus-formed inner space 13 can accommodate an insert 6.

FIG. 7 represents a variation of the housing 5 depicted in FIG. 6 according to another aspect of an embodiment of the present. This aspect differs in that instead of the connecting points 31, longitudinally formed connecting areas 32 for connecting the two plates 29 are arranged with interruptions along an imaginary line. Thus, a pipe-like inner space 13 with a lens-like inner space cross-section 13, which can accommodate an insert 6, is obtained respectively between two connection areas 32.

The housing 5 depicted in FIG. 8, according to yet another aspect of an embodiment of the present invention, likewise comprises a plurality of plates 29 arranged substantially parallel to each other. The plurality of plates 29 are held at holding areas 33 and spaced apart using a holding wall 34 such that an inner space 13 arises. An inner space cross-section 12 of inner space 13 is sufficient to accommodate the inserts 6. The plates 29 include convexities 35 that, via curves, partially complement the cross-sectional form of the insert 6, so that the inserts 6 can be fixably arranged in inner space 13.

FIG. 9 includes a reactor 1, according to an aspect of an embodiment of the present invention, in which a reactant gas is introduced via a reactant gas feed 37. First, the reactant gas is communicated for reaction to one of a plurality of reaction areas 2, including a solid-state catalyst 3, all of which are not shown but are, however, identically designed, and the reaction product arising therefrom is communicated to a heat exchanger area 4 with a housing 5 that includes an insert 6. The product gas cooled in the heat exchanger area 4 is converted in a further reaction area 15, which includes a further catalyst 42, into a further product that is likewise communicated in gaseous form to a further heat exchanger area 36, likewise equipped with a housing 5 that includes an insert 6. The further product gas, optionally cooled in the further heat exchanger area 36, is communicated via product gas exit 38 to a quench area 39. In the quench area 39, the further product gas can be brought into contact with a fluid such as water or solvent or solvents boiling above about 100° C. The fluid phase including the further product obtained in the quench area 39 is communicated for further processing to a purification area 40. Purification area 40 can be a distillation devices or crystallization devices alone or distillation devices and crystallization devices in combination. For the case that the thus-obtained purified product, for example acrylic acid, should be subjected to a further processing, in particular to polymerization, for example for the production of a superabsorbent polymer, the purified product obtained in the purification area 40 is communicated to a polymerization area 41. The polymerization area 41 can be in a spatial communication with the purification area 40, with the purification area 40 and the quench area 39, or with the purification area 40, the quench area 39, and the reactor 1. A spatial communication of this type is then in particular given if the arrangement occurs at a production plant.

FIG. 11 shows a combination of two housings 5 formed using thermoplates, according to an aspect of an embodiment of the present invention. Included in the interstices 59, which are limited by holding walls 34 that function as an actual housing 5, are insert 6 and/or catalyst 3. The interstices 59 include wavy gaps through which either a hot product gas 26 with a cooling agent 28, or, in the case of a reaction, with a reactant gas 25, can flow. Furthermore, two or more inserts 6 can be combined using an insert connection 60 into insert modules 61 that facilitates the handling of larger numbers of inserts.

Test Methods

It should generally be noted with the test method for the selection of suitable inserts according to the invention that the shape of the cross-section of the cladding pipe 43 corresponds to the form of the cross-section of the insert and is not bigger than that of the housing for which the insert is provided. This is particularly the case for inserts with spring elements. For example, with a cylindrical element, a cladding pipe 43 with a round cross-section should be selected. If the cross-section of the insert is lens-like, the test method should be carried out in a cladding pipe 43 with likewise lens-like cross-section.

As shown in FIG. 10, the measuring device consists of vertical cladding pipe 43 that is formed from a simple carbon steel (heat conduction capacity approximately 50 W/mK) with a wall thickness of 2 mm. The cladding pipe 43 has an entry section and a heating area 53 following thereupon, which is wound with an electrical heating band 44. The windings of the heating band 44 lie directly upon the pipe outer wall 45 of the cladding pipe 43, so that a good heat transfer is ensured. The heating band 44 is provided with energy by means of an electrical capacity control, whereby the heating area 53 of the cladding pipe 43 is provided with a wall temperature. The heating band 44 consists of a continuous metal mesh band that is wound evenly with a winding distance of 30 mm in heating area 53 on cladding pipe 43. The heating band 44 has a nominal output of 60 W at an input supply voltage of 27 Volt. Beneath heating area 53, the cladding pipe 43 extends by a further 100 mm without a heating band winding 44. The heating area 53 comprises a sample chamber 57 for accommodation of a sample 48 with a probe length PL. The length of the heating area 53 and PL are the same. The entry section has four times the length of PL. At the ends of the cladding pipe 43 lying opposite the heating area 53 of the cladding pipe 43, this is closed by a stopper-like seal. In order to prevent heat loss by convection and/or radiation, the windings of the heating band 44 in the heating area 53 are protected by a 150 mm thick insulation of mineral wool. At the upper end of the cladding pipe 43, a pressure measurement lance 47 is introduced vertically, held by the stopper-like seal 50. By means of the pressure measurement lance 47, the cladding pipe 43 can be provided with a gas flow. By means of the arrangement of manometer 54 in flow direction 51 via a baffle 49 and manometer 54′, the pressure loss of the gas communicated through the cladding pipe 43 and/or to the sample can be determined. The gas temperature before the sample 48 (Tᵢₙ) is determined by using a Ni 100 thermometers (TI 101), whose measurement tip is located centrally 3 mm above the sample 48, the thermometer being mounted centrally in the pipe cross-section of the cladding pipe 43. The gas temperature after sample 48 (Tₒᵤₜ) is determined by using a Ni 100 thermometers (TI 102), whose measurement tip is situated centrally 3 mm below the sample 48, the thermometer is mounted centrally in the pipe cross-section of the cladding pipe 43. With the Ni 100 thermometers (TI 103), the temperature (T_{wall}) at the pipe outer wall 45 in the section of the heating area 53 is determined.

Determination of Pressure Loss

In order to determine the pressure loss Δp, pressures PG1 and PG2 are determined by manometers 54 and 54′. Δp can be calculated by means of the mathematical relationship shown in formula I.

$$Δ p = \frac{( PG 2 ) * 0 , 3}{( PG 1 - PG 2 )} [ mbar ] \qquad Formula I$$

Heat Transfer Coefficient

The heat transfer coefficient, k, results in the mathematical relationship of formulas II and III, whereby Q is the heat conduction and I is the current of the electrical heating of the heating area 53, m_{Gas} is the mass flow of the air, Aₚᵢₚₑ, and ΔTᵢₙ is the the logarithmic temperature difference according to Dubbel, Taschenbuch für den Maschinenbau, 19^{th} edition, Springer Verlag Berlin 1997.

$$\begin{matrix}k = \frac{Q}{{m}_{Gas} {A}_{pipe} Δ {T}_{ln}} & Formula II \\ k = \frac{Q}{{m}_{Gas} {A}_{pipe} \frac{( {T}_{wall} - {T}_{i n} ) - ( {T}_{wall} - {T}_{out} )}{ln \frac{( {T}_{wall} - {T}_{i n} )}{( {T}_{wall} - {T}_{out} )}}} & Formula III\end{matrix}$$

Method

a. Sample Preparation

The samples 48 given in the following table were inserted into the sample chamber 57 at room temperature.

b. Pressure Loss Measurement

At manometer 54, a pressure of 300 mbar was applied via a suspended ball flow meter 58. The pressure measurement lance 47 was placed on the cladding pipe 43 and sealed with stopper 50 and PG2 was measured at manometer 54′.

c. Heat Transfer Coefficient Measurement

The empty pipe speeds v given in the following table were adjusted by means of valve 56. Energy is supplied via heating area 53 and transferred in the form of heat to the gas (air) that is flowing past. The amount of energy is selected such that after reaching a steady state, Tₒᵤₜ is 90° C. Tᵢₙ and T_{wall} are then measured.

d. Coking

The suitability of the different inserts was determined by means of the frequency of cleaning work necessary for the individual inserts because of residues arising from coking. These results are likewise provided in the following table. For this purpose, the down time with raschig rings is set to 1 in order to obtain the “relative down time.”

TABLES
Part I. Sample characterization

| | | Pressure Loss | | | |
|---|---|---|---|---|---|
| | | “Δp” at an | | | |
| | | empty pipe | | | |
| | Degree of | speed “v” | Heat transfer coefficient [W/m²/K] “k” at | | |
| Material | perforation | 0.970 m/s | various empty pipe speeds “v” [m/s] | | |
| [−] | [%] | [mbar/m] | 0.485 m/s | 0.728 m/s | 0.970 m/s |
| a | 57.0 | 7.2 | 8 | 11 | 13 |
| b | 94.1 | 0.5 | 5 | 6 | 7 |
| c | 93.3 | 1.5 | 1 | 3 | 5 |
| Sample A | 98.4 | 0.05 | 5 | 6 | 6 |
| Sample B | 97.7 | 0.07 | 6 | 9 | 11 |
| Sample C | 96.5 | 0.09 | 6 | 8 | 10 |
| Sample D | 94.9 | 0.1 | 7 | 10 | 12 |

a raschig rings fill
b wire mesh 28 mm circular diameter, 1 m length (Company Anselm GmbH & Co. KG)
c wire mesh 28 mm circular diameter and partially flat wire, 1 m length (Company An-
selm GmbH & Co. KG)
The “sample A to D” wire inserts with loops with 1 m length (Company Cal Gavin Ltd,
GB)

Part II. Down time and thermal compression quotient

| | Relative Down | Heat pressure quotient “Λ” [W/m²/K/(mbar/m)] | | |
|---|---|---|---|---|
| Material | Time | at various empty pipe speeds “v” [m/s] | | |
| [−] | [−] | 0.485 m/s | 0.728 m/s | 0.970 m/s |
| a | 1 | 1.1 | 1.5 | 1.8 |
| b | 0.6 | 1.0 | 12.0 | 14.0 |
| c | 0.5 | 0.7 | 2.0 | 3.3 |
| Sample A | 3 | 100.0 | 120.0 | 120.0 |
| Sample B | 2.8 | 85.7 | 128.6 | 157.1 |
| Sample C | 2.3 | 66.7 | 88.9 | 111.1 |
| Sample D | 2.1 | 70.0 | 100.0 | 120.0 |

The inserts according to “sample A to D” have the best relative down times
with very low pressure losses compared to the other samples.

List of Reference Numerals
1 reactor
2 reaction area
3 solid-state catalyst
4 heat exchanger area
5 housing
6 insert
7 element
8 fiber-like material
9 core
10 longitudinal element
11 winding
12 inner space cross-section
13 inner space
14 inner wall
15 further reaction area
16 central longitudinal axis
17 recess
18 element area
19 element axis
20 deposit
21 cooling element
22 outer wall
23 reactor plate
24 hole
25 reactant gas
26 hot product gas
27 cooled product gas
28 cooling agent
29 plates
30 weld seam
31 connection point
32 connection area
33 holding area
34 holding wall
35 convexity
36 further heat exchanger area
37 reactant gas feed
38 product gas exit
39 quench device
40 purification area
41 polymerization area
42 further catalyst
43 cladding pipe
44 heating band
45 pipe outer wall
46 insulation
47 pressure measurement lance
48 sample
49 baffle
50 seal
51 flow direction
52 entry section
53 heating area
54 manometer
55 gas supply
56 valve
57 sample chamber
58 suspended bowl flowmeter
59 interstice
60 insert connection
61 insert module

1-31. (canceled)

32. A reactor comprising at least:
(a) a reaction area comprising at least one solid-state catalyst; and
(b) a coolable heat exchanger area comprising at least one housing at least partially accommodating an insert,
wherein the reaction area and the coolable heat exchanger area are in fluid-communication.

33. The reactor according to claim 32, wherein the insert comprises at least one of the following properties determined according to the test methods described herein:
(A) a heat pressure quotient Λ1 at an empty pipe speed v of 0.485 m/s of greater than 1.11 W/m²/K/(mbar/m);
(B) a heat pressure quotient Λ2 at an empty pipe speed v of 0.728 m/s of greater than 1.53 W/m²/K/(mbar/m);
(C) a heat pressure quotient Λ3 at an empty pipe speed v of 0.970 m/s of greater than 1.81 W/m²/K/(mbar/m); or.
(D) any combination of any of the preceding.

34. The reactor according to claim 32, wherein the insert comprises a plurality of elements.

35. The reactor according to claim 32, wherein the insert comprise a degree of perforation of at least about 30.

36. The reactor according to claim 34, wherein the elements at least partially comprise a fiber-like material.

37. The reactor according to claim 34, wherein at least two of the plurality of elements at least partially comprise a fiber-like material formed in one piece.

38. The reactor according to claim 34, wherein at least a part of the plurality of elements are arranged around a core.

39. The reactor according to claim 38, wherein the core accommodates at least a part of the plurality of elements.

40. The reactor according to claim 38, wherein the core comprises at least two longitudinal elements.

41. The reactor according to claim 40, wherein the at least two longitudinal elements are twisted around each other to form one or more windings.

42. The reactor according to claim 41, wherein the at least one of the elements is accommodated in the one or more windings.

43. The reactor according to claim 34, wherein the plurality of elements comprises a wire.

44. The reactor according to claim 38, wherein the core comprises a wire.

45. The reactor according to claim 43, wherein the wire comprises a metal wire.

46. The reactor according to claim 44, wherein the wire comprises a metal wire.

47. The reactor according to claim 32, wherein the insert at an inner space cross-section of the housing substantially fills this inner space cross-section.

48. The reactor according to claim 32, wherein the housing comprises a cylindrical inner space.

49. The reactor according to claim 32, wherein the insert has a cylindrical form.

50. The reactor according to claim 34, wherein at least a part of the plurality of elements contact an inner wall of the housing.

51. The reactor according to claim 34, wherein at least a part of the plurality of elements comprise loops.

52. The reactor according to claim 32, further comprising at least one additional reaction area in fluid-communication with the heat exchanger area.

53. The reactor according to claim 52, wherein the solid-state catalyst in the reaction area and a further catalyst in the additional reaction area are different.

54. The reactor according to claim 32, wherein a part of the insert at least partially extends into the reaction area.

55. The reactor according to claim 54, wherein the part of the insert that extends into the reaction area comprises a catalyst.

56. The reactor according to claim 32, wherein the reaction area further comprises an additional insert comprising a catalyst.

57. A process for oxidation of a hydrocarbon comprising the steps of:
(a) communicating a hydrocarbon in a gaseous state to at least one solid-state catalyst of a reaction area of a reactor;
(b) oxidizing a portion of the hydrocarbon to hydrocarbon product; and
(c) cooling at least a portion of the a hydrocarbon product by communicating the at least a portion of the a hydrocarbon product to a heat exchanger area comprising an insert,
wherein the insert comprises at least one of the following properties determined according to the test methods described herein:
(A) a heat pressure quotient Λ1 at an empty pipe speed v of 0.485 m/s of greater than 1.11 W/m²/K/(mbar/m);
(B) a heat pressure quotient Λ2 at an empty pipe speed v of 0.728 m/s of greater than 1.53 W/m²/K/(mbar/m);
(C) a heat pressure quotient Λ3 at an empty pipe speed v of 0.970 m/s of greater than 1.81 W/m²/K/(mbar/m); or
(D) any combination of any of the preceding.

58. The process according to claim 57, wherein the hydrocarbon comprises an unsaturated hydrocarbon.

59. The process according to claim 57, wherein the hydrocarbon comprises propene.

60. The process according to claim 59, wherein the oxidized hydrocarbon product comprises acrolein or acrylic acid.
